(19) United States
(12) Patent Application Publication
(10) Pub. No.: US 2003/0000808 A1
(43) Pub. Date: Jan. 2, 2003

(54) Device for monitoring a conveyor facility

(76) Inventor: Bernd Kusel, Hamburg (DE)

Correspondence Address: WILLIAM COLLARD, COLLARD & ROE, P.C., 1077 NORTHERN BOULEVARD, ROSLYN, NY, 11576, US

(21) Appl. No.: 10/182,007

(22) PCT Filed: Jan. 11, 2001
(86) PCT No.: PCT/DE01/00084

(30) Foreign Application Priority Data
Feb. 2, 2000 (DE) 100 04 360.7

(51) Int. Cl. B65G 43/00

(52) U.S. Cl. 198/502.1

(57) ABSTRACT

The invention concerns a device for monitoring a conveyor facility having a top strand and a bottom strand. Said conveyor facility comprises a conveyor belt (1) made of elastomer material having a carrying side for the material to be conveyed and a backing side (3), whereby the conveyor belt has at the most one strengthening support. The conveyor facility also comprises other parts such as driving drum, tail pulley, deflection drum, carrying rollers (5), supporting structure, feed chute and optionally other components. The device according to the invention is characterized in that it includes an optoelectronic system (4) in area (X) where there are no carrying rollers (5). Said system optically detects and reports any damage to the conveyor belt (1) by monitoring the backing side (3), optionally in connection with automatic switch-off of the conveyor facility.

The invention relates to a device for monitoring a conveyor system having a top strand and a bottom strand and comprising

a conveyor belt of elastomeric material with a top side for the material to be conveyed and a bottom side, the conveyor belt usually being provided with an embedded carcass, and

other system parts, namely drive pulley, tail pulley, corner pulley, support rollers, conveyor structure, feed chute and possibly further components.

Conveyor belts are subjected to large stresses and strains where the loose material to be conveyed is dropped on them. Since uniform lump size cannot be ensured, especially in mining, damage is frequently suffered by the top side of the conveyor belt, usually associated with consequent damage involving the carcass and the bottom side. Such damage then becomes increasingly greater and ultimately leads to failure of the conveyor belt in the absence of timely repairs.

In addition, foreign bodies can cause isolated perforations of the conveyor belt. Foreign bodies can be chute parts, support rollers and other components of the conveyor system. Tools, trimming residues in foundries and sharp-edged materials present in the conveyed product are also hazard sources. If a foreign body is dropped in unfavorable manner, the body can become jammed in a system part. The conveyor belt becomes perforated and continues to run almost without hindrance, because the force driving the conveyor belt is much greater than the resistance of the conveyor belt to the jammed foreign body. This situation results in lengthwise slitting of the conveyor belt. In most cases, it is then impossible or uneconomical to repair the conveyor belt. The resulting damage is considerable.

Beyond this, conveyor belts with steel cables as tension supports are exposed to further hazards on the bottom side of the conveyor belt. For example, individual cables can stick out, especially within the region of joints. These cables become trapped in the system construction, for example in the support rollers, and thus lead to considerable damage or even complete destruction of the conveyor belt.

Similarly, if the covering rubber of the bottom side becomes damaged, dangling rubber shreds can be formed and also become trapped in the construction.

Heretofore such forms of damage have frequently been detected through visual inspections by the system personnel.

Automatic detection has been achieved heretofore in the form of mechanical devices, such as a wire suspended underneath the conveyor belt. As soon as this wire becomes entangled with dangling parts of the belt, the anchoring of the wire is detached and thus generates an electrical signal.

Another device comprises conductor loops (German Patent C 4444264), which are vulcanized into the conveyor belt at specified intervals, such as 50 m. In the event of damage to a conductor loop, especially because of slitting effects, an electroinductive circuit is broken, leading via detectors to shutdown of the conveyor system. Conductor loops are made of fine metal cords, which react sensitively to external influences such as constant impacts as well as alternation of longitudinal and transverse bending. They frequently cause false alarms. Their service life is very limited. Moreover, this method is not suitable for detection of all of the aforesaid causes of damage.

The object of the invention is now to provide, for monitoring a conveyor system, a device that is capable of early detection of many forms of damage to the conveyor belt and that in addition is wear-free, requires little maintenance and is economic with minimum possible complexity.

This object is achieved according to the body of claim 1 by the fact that the device is equipped, in the region in which support rollers are not present, with an optoelectronic system that optically detects and signals damage to a conveyor belt by observing the bottom side, and if necessary shuts down the conveyor system automatically.

Expedient embodiments of the invention are specified in claims 2 to 7.

The invention will now be explained on the basis of practical examples with reference to schematic drawings, wherein:

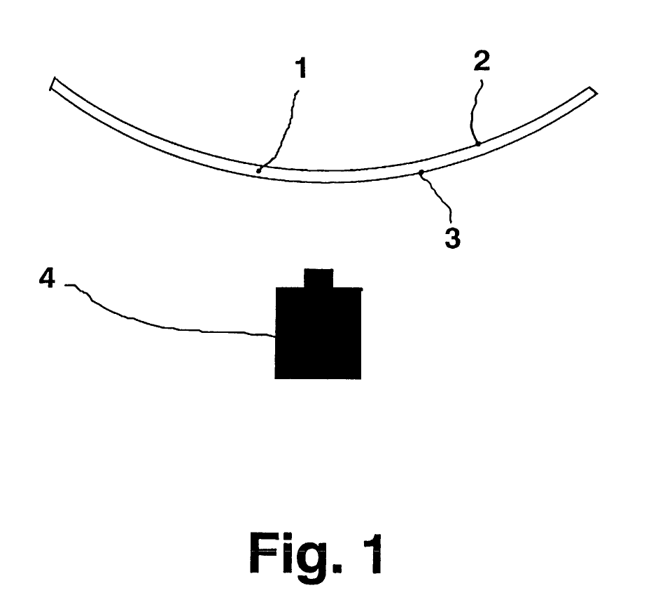

FIG. 1 shows a cross section of a conveyor belt whose bottom side is observed by means of an optoelectronic system;

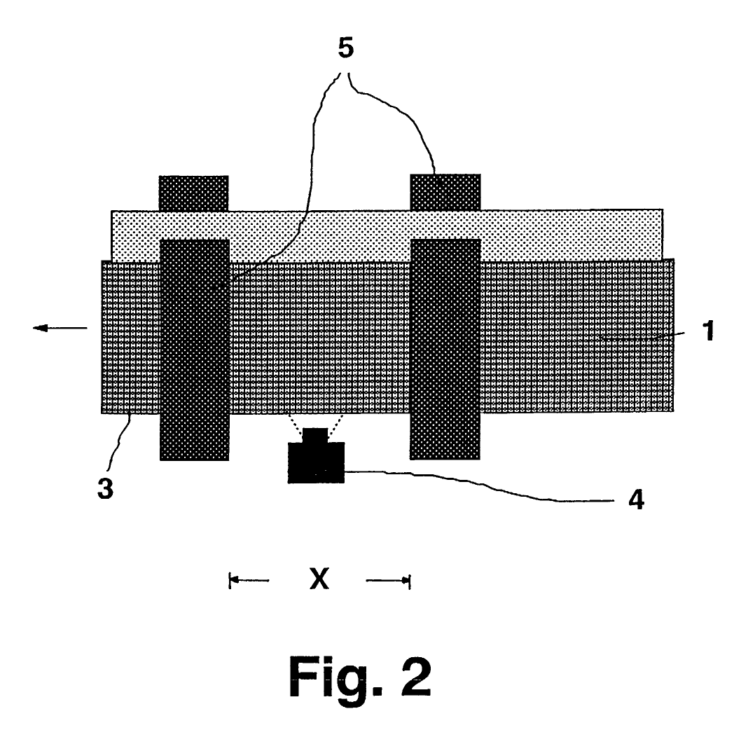

FIG. 2 shows a side view of a conveyor belt whose bottom side is observed by means of an optoelectronic system;

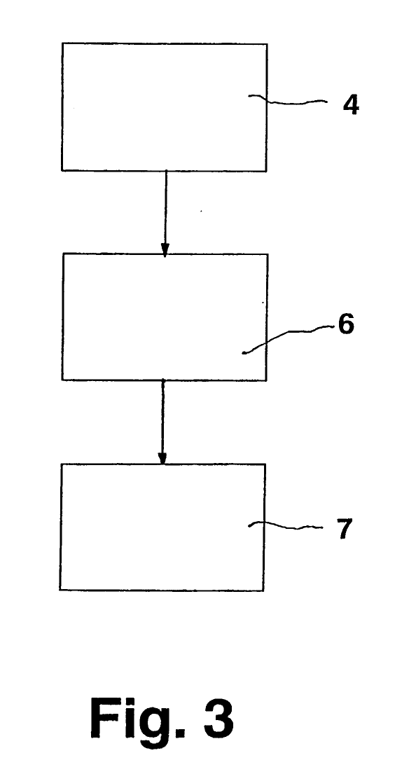

FIG. 3 shows how the optoelectronic system is coupled to a process computer and a drive controller.

The reference symbols listed below are used in connection with these figures:

1 Conveyor belt

2 Top side

3 Bottom side

4 Optoelectronic system

5 Support rollers

6 Process computer

7 Drive controller

FIG. 1 shows a part of the conveyor system, wherein conveyor belt 1 of elastomeric material, in other words rubber or rubber-like plastic, comprises a top side 2 for the material to be conveyed and a bottom side 3. The conveyor belt is usually provided with an embedded carcass, for example using steel cables.

An optoelectronic system 4 in the form of a digital line-scanning or area-scanning camera is now pointed toward bottom side 3, substantially the entire region of this bottom side being scanned. In this way observation of damage such as dangling rubber-shreds can be achieved particularly well by the optoelectronic system.

FIG. 2 shows a conveyor system in conveying direction (arrow direction) comprising conveyor belt 1, support rollers 5 and optoelectronic system 4, which is disposed in region X, where support rollers are not present, so as specifically to observe bottom side 3 for damage.

Optoelectronic system 4 is preferably installed in the top strand of the conveyor system.

In a further advantageous embodiment, optoelectronic system 4 is connected to a blower-type cleaning device. In this way the optics are kept clean.

FIG. 3 shows the cooperation of optoelectronic system 4, process computer 6 and drive controller 7, specifically from the following viewpoints:

Optoelectronic system 4 signals damage to the conveyor belt. This information is recorded and evaluated by means of process computer 6, especially in combination with an acoustic and/or optical warning.

By virtue of the fact that drive controller 7 is coupled to optoelectronic system 4 via process computer 6 as the interface, the conveyor plant can be shut down automatically, especially if major damage is detected.

Drive controller 7 comprises a rotating part of the conveyor system, preferably the drive pulley or tail pulley.

1. A device for monitoring a conveyor system having a top strand and a bottom strand and comprising
a conveyor belt (1) of elastomeric material with a top side (2) for the material to be conveyed and a bottom side (3), the conveyor belt usually being provided with an embedded carcass, and
other system parts, namely drive pulley, tail pulley, corner pulley, support rollers (5), conveyor structure, feed chute and possibly further components, characterized in that
the device is equipped, in the region (X) in which support rollers (5) are not present, with an optoelectronic system (4) that optically detects and signals damage to a conveyor belt (1) by observing the bottom side (3), and if necessary also shuts down the conveyor system automatically.

2. A device according to claim 1, characterized in that the optoelectronic system (4) comprises at least one digital line-scanning or area-scanning camera, especially in the form of a digital line-scanning camera.

3. A device according to claim 1 or 2, characterized in that the optoelectronic system (4) trips an acoustic and/or optical warning in the event of damage to the conveyor belt (1).

4. A device according to one of claims 1 to 3, characterized in that the optoelectronic system (4) is installed in the top strand of the conveyor system.

5. A device according to one of claims 1 to 4, characterized in that the optoelectronic system (4) is coupled to a process computer (6).

6. A device according to claim 5, characterized in that the process computer (6) is coupled to a drive controller (7), specifically for the purpose of automatic shutdown of the computer system.

7. A device according to one of claims 1 to 6, characterized in that the optoelectronic system (4) is connected to a blower-type cleaning device.
